(19) United States
(12) Patent Application Publication
(10) Pub. No.: US 2010/0155222 A1
(43) Pub. Date: Jun. 24, 2010

(54) APPLICATION OF DENSE PLASMAS GENERATED AT ATMOSPHERIC PRESSURE FOR TREATING GAS EFFLUENTS

(75) Inventors: Jean-Christophe ROSTAING, Versailles (FR); Daniel Guerin, Chelles (FR); Christian Larquet, Guyancourt (FR); Chun-Hao Ly, Tsukuba (JP); Michel Moisan, Outremont (CA); Hervé Dulphy, Jarrie (FR)

Correspondence Address: AIR LIQUIDE USA LLC;Intellectual Property, 2700 POST OAK BOULEVARD, SUITE 1800, HOUSTON, TX, 77056, US

(73) Assignee: L'Air Liquide, Société Anonyme pour I'Exploitation des Procédés Georges Claude, Paris (FR)

(21) Appl. No.: 12/719,346

(22) Filed: Mar. 8, 2010

Related U.S. Application Data
(62) Division of application No. 10/478,596, filed on May 17, 2004.

(30) Foreign Application Priority Data
May 31, 2001 (FR) 01/07150

(51) Int. Cl. B01J 19/08

(52) U.S. Cl. 204/164

(57) ABSTRACT

The invention concerns a system for treating gases such as PFC or HFC with plasma, comprising: (6) pumping means (6) whereof the outlet is at a pressure substantially equal to atmospheric pressure, plasma generator (8), at the pump output, to produce a plasma at atmospheric pressure.

### CROSS REFERENCE TO RELATED APPLICATIONS

This application is a continuation application of pending application Ser. No. 10/478,596 filed Nov. 21, 2003, which is a national stage entry under 21 USC §371 of PCT/FR02/01701 filed May 21, 2002, which claims priority to French application 01/07150 filed May 31, 2001, the entire contents of which are incorporated herein by reference.

### BACKGROUND

The invention relates to the field of the treatment of gases by plasma techniques, and especially the treatment of gases such as perfluorinated gases (PFCs), particularly perfluorocarbon gases, and/or hydro-fluorocarbon gases (HFCs), for the purpose of destroying them.

It relates to a unit or system for treating such gases and to a process for treating these gases.

One industry particularly concerned by these problems is the semiconductor industry. This is because the manufacture of semiconductors is one of the industrial activities consuming significant tonnages of perfluorinated gases (PFCs) and hydrofluorocarbon gases (HFCs).

These gases are used in plasma etching processes for etching patterns in integrated electronic circuits and in plasma cleaning processes, especially for cleaning the reactors for producing thin-film materials by chemical vapour deposition (CVD).

They are also used in processes for the production or growth or etching or cleaning or treatment of semiconductors or semiconductor or thin-film devices or semiconductor or conducting or dielectric thin films, or substrates, or else in processes for removing photosensitive resins used for microcircuit lithography.

To do this, these PFC and/or HFC gases are dissociated within a cold electrical discharge plasma in a chamber or reactor, in order to give, in particular atomic fluorine.

Atomic fluorine reacts with the atoms at the surface of a material to be treated or to be etched, in order to give volatile compounds which are extracted from the chamber by a vacuum pumping system and sent to the exhaust unit of the system.

Perfluorinated or hydrofluorocarbon gases are not in general completely consumed by the aforementioned processes. The amounts discharged by the equipment may exceed 50% of the PFC or HFC inflow.

Perfluorinated or hydrofluorocarbon gases are especially characterized by their great chemical stability and by their very high absorption in the infrared. They are therefore suspected of being able to make a significant contribution to the overall heating of the climate by reinforcing the greenhouse effect.

Certain industrialized countries are in principle committed to reducing their emission of greenhouse-effect gases.

Certain industries consuming these gases have chosen to anticipate the changes in regulations. In particular, the semiconductor industry is in the forefront in adopting voluntary emission reduction policies.

There are several technological ways of achieving these reductions in emissions.

Among the various conceivable solutions, optimization of the current processes seems limited in its possibilities. The use of techniques involving alternative chemistry is inappropriate in most current equipment. As regards the technique of recovering and recycling unconverted PFCs or HFCs, this proves to be very expensive if the aim is to provide products with a purity sufficient to be able to reuse them in the process.

There are also techniques for the abatement or destruction of unconverted PFCs or HFCs leaving the reactors.

Among the known abatement techniques, mention may be made of the thermal conversion of PFCs, in a burner or an electric furnace, catalytic oxidation and plasma techniques.

These techniques have a limited efficiency, especially with regard to the most stable molecules such as CF₄, or do not allow satisfactorily efficient treatment of PFC streams encountered in practice in semiconductor fabrication plants, with flow rates, in the highest cases, typically of the order of a few hundred standard cm³ per minute.

Documents EP 874 537, EP 847 794 and EP 820 801 describe PFC or HFC gas abatement solutions, but not one gives any practical, in line, implementation, within the context of a semiconductor production unit. Some of the solutions proposed (EP 820 801 and EP 874 537) relate exclusively to the case of carrier gases of the rare-gas type, which can be implemented in a laboratory, but not in such a production unit where the consumption of these rare gases as dilution gases is excluded by manufacturers.

None of the other “plasma” type solutions, known at the present time for treating effluents of processes other than semiconductor fabrication processes, allows satisfactorily efficient treatment of PFCs with high flow rates, such as those encountered in the field of semiconductor fabrication, typically of the order of a few hundred standard cm³ per minute.

The same problems arise in the case of all the activities involving the techniques used in the semiconductor field, and especially all the techniques using PFC and/or HFC gases.

### SUMMARY OF THE INVENTION

The invention relates to a system for treating gases with plasma, comprising:
a pumping means, the outlet of which is at a pressure substantially equal to atmospheric pressure;
means, downstream of the pump, for creating an atmospheric-pressure plasma.

Such a system proves to be well suited to the treatment of PFC or HFC type gases mixed with a carrier gas at a pressure substantially equal to, or of the order of, atmospheric pressure, in particular in the case of PFCs with concentrations of the order of 0.1% to 1% in a few tens of liters of nitrogen or air per minute.

Preferably, the plasma is a non-local thermodynamic equilibrium plasma, that is to say a plasma in which at least one region of the discharge is not in local thermodynamic equilibrium.

A plasma sustained at high frequency, within the MHz or GHz range, for example at a frequency greater than 50 MHz, or of the order of a few hundred MHz or a few GHz, makes it possible to sustain such a non-local thermodynamic equilibrium plasma.

In order to achieve a high conversion efficiency of the plasma, means for generating a plasma, downstream of the pump, are chosen so as to produce an electron density of at least 10¹² cm⁻³, for example between 10¹² and 10¹⁵ cm⁻³ or preferably between 10¹³ and 10¹⁴ cm⁻³.

Preferably, the pressure drop downstream of the pump is limited to less than 300 mbar.

Now, the use of an atmospheric-pressure plasma, downstream of the pump, may cause in the tube, or in the generally tubular dielectric chamber, within which the discharge is sustained, radial contraction phenomena in the plasma which are deleterious to effective operation of the treatment system according to the invention.

According to one embodiment, a plasma tube having a diameter of between 8 mm and 4 mm, or between 8 mm and 6 mm, is selected so as to maintain a moderate degree of contraction.

A plasma tube having a length of between 100 mm and 400 mm may furthermore be selected so as to limit the pressure drops downstream of the pump.

According to another aspect, the means for generating a plasma comprise a plasma discharge tube, the gas to be treated passing through this tube downwards.

This makes it possible to limit the risks of contaminating or blocking the tube with deposited liquids which might result in the coupling of the microwave power into the plasma being disturbed or in an excessively large pressure drop downstream of the pump.

Draining means may therefore be provided in the bottom position of the plasma tube so as to recover the liquid condensates and to remove them from the treatment circuit.

According to yet another aspect, oven-drying or tapping means may be provided in the gas path so as to limit the deposition of solids or condensation which might increase the pressure drop downstream of the pump.

The invention also relates to a reactor unit comprising a reaction chamber, producing at least one PFC or HFC gas, and furthermore including a PFC or HFC treatment system as described above.

The reaction chamber is, for example, an item of equipment for the production or growth or etching or cleaning or treatment of semiconductor or thin-film devices or semiconductor or conducting or dielectric thin films or substrates, or else is a reactor for removing photosensitive resins used for microcircuit lithography, or a reactor for depositing thin films during plasma cleaning.

The invention also relates to equipment for producing or growing or etching or cleaning or treating semiconductors or semiconductor or thin-film devices or semiconductor substrates, comprising:
a reactor for producing or growing or etching or cleaning or treating semiconductors or semiconductor or thin-film devices or semiconductor or conducting or dielectric thin films or substrates, or else a reactor for removing photosensitive resins used for microcircuit lithography, or a reactor for depositing thin films during plasma cleaning;
first means for pumping out the atmosphere in the reactor;
a treatment system as described above.

The treatment system is preferably located near the reactor. Advantageously, it may be located on a facilities floor of the treatment or production or etching or cleaning unit, or else on a floor of a fabrication or treatment or production or etching or cleaning shop.

The invention also relates to a process for treating gases with plasma, comprising:
pumping of the gas to be treated, at a pressure substantially equal to atmospheric pressure;
treatment of the said gas with an atmospheric-pressure plasma.

The gas to be treated may be premixed with a carrier gas, at substantially atmospheric pressure, for example nitrogen or air, injected using nitrogen or air injection means.

The nitrogen or air has a diluting effect (in the case of dangerous reaction products) and a plasma-generating role.

Advantageously, the plasma treatment takes place in a discharge tube, the process including a prior step of matching the diameter of this tube so as to limit the radial discharge contraction phenomena in this tube.

The process may be applied to a chemical reaction in a reactor, the reaction producing or emitting at least one waste gas to be treated by the treatment process.

The said reaction may, for example, be a reaction for the production or growth or etching or cleaning or treatment of semiconductors or semiconductor or thin-film devices or semiconductor or conducting or dielectric thin films or substrates, or else a reaction for the removal of photosensitive resins used for microcircuit lithography, or a reaction for the deposition of thin films during plasma cleaning, using PFC and/or HFC gases, the waste gases being in particular PFC and/or HFC gases.

### BRIEF DESCRIPTION OF THE FIGURES

The features and advantages of the invention will become more clearly apparent in the light of the description which follows. This description relates to illustrative examples, given by way of explanation but implying no limitation, with reference to the appended drawings in which:

FIG. 1 shows a diagram of semiconductor production equipment according to the invention;

FIG. 2 shows a diagram of a plasma source; and

FIGS. 3 and 4 show schematically semiconductor production plants.

### DETAILED DESCRIPTION OF PREFERRED EMBODIMENTS

As used herein, the term ‘semiconductor fabrication’ is defined as an apparatus or process which includes:
a reactor for removing photosensitive resins used for microcircuit lithography,
a reactor for depositing thin films during plasma cleaning, or
the production, growth, etching cleaning or treatment of
   semiconductor or thin-film devices,
   semiconductor, conducting, or dielectric thin films,
   semiconductor, conducting, or dielectric substrates,

As used herein, the term ‘target frequency’ is defined as a frequency within a band centered on 433.92 MHz, 915 MHz, 2.45 GHz, or 5.80 GHz.

The invention will firstly be described within the context of a semiconductor production plant.

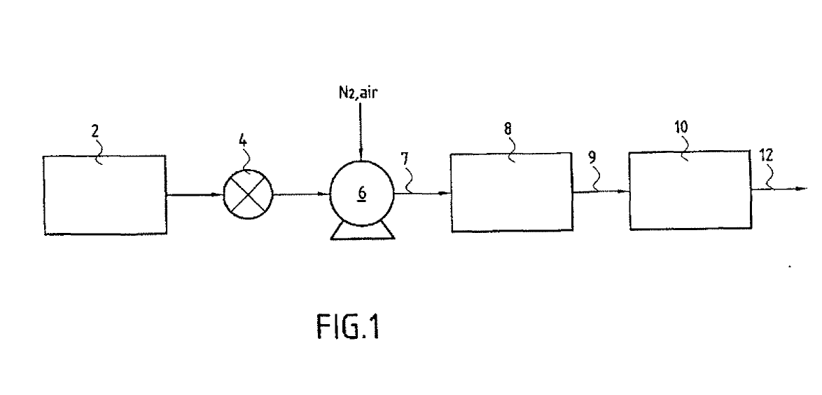

Such a plant, provided with a treatment system according to the invention, comprises, as illustrated in FIG. 1, a production reactor or etching machine 2, a pumping system comprising a high-vacuum pump 4, such as a turbomolecular pump 4, and a roughing pump 6, and means 8 for the abatement of PFC and/or HFC compounds, of the plasma generator type.

In operation, the pump 4 maintains the necessary vacuum in the process chamber and extracts the gases discharged.

The reactor 2 is fed with the gases for treating the semiconductor products, in particular PFC and/or HFC gases. Gas feed means therefore feed the reactor 2, but these are not shown in the figure.

Typically, these gases are introduced into the reactor with a flow rate of the order of about ten, or a few tens, to a few hundred sccm (standard cubic centimeters per minute), for example between 10 and 200 or 300 sccm.

In general, these gases are not consumed entirely by the semiconductor fabrication or treatment process, this being so up to proportions possibly greater than 50%. It is therefore quite common to have PFC and/or HFC flow rates, downstream of the roughing pump 6, of the order of a few tens to a few hundred sccm, for example between 10 sccm and 100 or 200 sccm.

The means 8 can be used for carrying out a treatment (dissociation or irreversible conversion) of these unconsumed PFC and/or HFC compounds, but they may also produce, thereby, by-products such as F₂ and/or HF and/or SiF₄ and/or WF₆ and/or COF₂ and/or SOF₂ and/or SO₂F₂ and/or NO₂ and/or NOF and/or SO₂.

These means 8 are means for dissociating the molecules of the incoming gases in the means 8 and for forming reactive compounds, especially fluorinated compounds.

More specifically, the plasma of the means 8 is used to ionize the molecules of the gas subjected to the plasma, by stripping off electrons from the initially neutral gas molecules.

Owing to the action of the discharge, the molecules of the gas to be treated or to be purified, and especially the molecules of the base gas, are dissociated so as to form radicals of smaller size than the initial molecules and, thereafter, as the case may be, individual atoms, the atoms and fragments of molecules of the base gas thus excited giving rise to substantially no chemical reaction.

After passing through the discharge, the atoms or molecules of the base gas are de-excited and recombine respectively, to become intact thereafter.

In contrast, the impurities undergo, for example, dissociation and/or irreversible conversion by the formation of new molecular fragments having chemical properties different from those of the initial molecules, which can thereafter be extracted from the gas by a suitable subsequent treatment.

A reactive unit 10 is used to make the compounds resulting from the treatment by the means 8 react with a corresponding reactive element (for example, a solid reactive adsorbent) for the purpose of destroying the said compounds. The gases resulting from the treatment by the means 10 (in fact, the carrier gas laden with PFC and/or HFC type compounds and/or other impurities such as those mentioned above) are then discharged into the ambient air, but without danger, with PFC and/or HFC proportions compatible with environmental protection (typically, less than 1% of the initial concentration) and very low, permitted proportions of harmful impurities, that is to say below the legal exposure limits, typically less than 0.5 ppm or less than 1 ppm.

For safety reasons, the gaseous effluents coming from the reactor or from the production chamber 2 are, downstream or in the exhaust of the roughing pump or the rough-vacuum pumping set, highly diluted in nitrogen (with an additive gas, namely oxygen) or air at substantially atmospheric pressure. The system therefore includes nitrogen (and oxygen) gas or air injection means, not shown in FIG. 1. The air, or nitrogen (and oxygen), is injected at the high-pressure stage of the roughing pump.

Preferably, dry nitrogen, obtained by cryogenic distillation, is injected as dilution gas. Thus, dilution reduces the problems (explained below) associated with the possible presence of residual moisture, which results in the formation of non-gaseous products (H₂SO₄ or HNO₃ or SiOₓN_{y}, or, in the case of tungsten etching, WOₓ or WOF₄) or other problems such as the hydrolysis of SiF₄ or WF₆, which results in depositions right before the decontamination plasma.

The fluid flow rate downstream of the roughing pump 6 is imposed by this dilution, the typical flow rates encountered being of the order of a few tens of liters per minute (for example, between 10 and 50 l/min) of nitrogen or air, which flow contains from 0.1% to 1% PFC and/or HFC.

The pressure, downstream of the pump, is of the order of atmospheric pressure, for example between 0.7 and 1.3 bar or between 0.8 and 1.2 bar.

The use, at atmospheric pressure, of a carrier gas such as air or nitrogen requires a large amount of energy to ionize the gas by plasma generation means 8 and to sustain the plasma (at least 150 W per centimeter of discharge tube, for example about 200 W per centimeter of discharge tube; according to another example, a power of between 150 and 500 W per cm of tube may be selected).

The plasma generated by the means 8 is preferably not in local thermodynamic equilibrium (LTE). This plasma may also be one in which at least one region of the discharge is not in local thermodynamic equilibrium. It is thus possible to use a microwave torch, generally classed in thermal plasmas, but the “envelope” region of which, forming an appreciable volume fraction of the discharge and in which most of the conversion reactions can take place, is substantially not in LTE.

Preferably, the discharge or the plasma source is of the type sustained by an HF field in the MHz and GHz range. At these high frequencies, the electrons respond predominantly, or exclusively, to the exciting field, hence the off-LTE character of these discharges. Controlling the deviation from thermodynamic equilibrium may allow the conversion chemistry to be optimized by controlling the nature of the by-products. Various external operational parameters have an influence on this deviation, for example the choice of dilution gas or the addition in small amounts of certain additive gases, or the excitation frequency. This frequency also has an effect on the electron density of the plasma, which in general increases with it. Plasmas sustained by microwave fields at atmospheric pressure have high densities (from 10¹² to 10¹⁵ cm⁻³ at 2.45 GHz, and more specifically from 10¹³ to 10¹⁴ cm⁻³ in nitrogen or air), which help to achieve a high efficiency in the conversion of PFCs and/or HFCs, including when they are in nitrogen or air.

In practice, the frequency will be chosen from one of the bands centered on 433.92 MHz, 915.00 MHz, 2.45 GHz, and 5.80 GHz. The band immediately below 40.68 MHz is already within the radiofrequency range, hence the plasma densities will be too low to obtain a high efficiency.

There are several generic families of high-frequency plasma sources that can operate at atmospheric pressure, resulting in ranges of different discharge characteristics, and having various advantages or disadvantages, especially as regards their design and manufacturing simplicity, their ease of implementation for the problem posed, and their cost.

Within the context of the envisaged application, the following four types of sources may be used.

The first type involves plasmas sustained within resonant cavities. A cavity may be supplied either via a waveguide or via a coaxial line. The spatial extension of the discharge is limited by the size of the cavity. The plasma electron density cannot significantly exceed the critical density at the frequency in question, unlike in particular surface-wave plasma sources.

Also relevant are plasmas sustained within a waveguide, which may in fact be likened to imperfect cavities. Such plasmas also suffer from the abovementioned two limitations, namely size and electron density. Furthermore, the maximum extent of the discharge corresponds to one of the dimensions of the cross section of the waveguide.

Torches represent a third type of high-frequency plasma source able to be used within the context of the present application. The discharge forms a load which, at the end of a length of transmission line (generally a coaxial line), absorbs the HF power. A torch can be supplied with power via a coaxial line or via a waveguide. An increase in the power results both in an increase in the density and the volume of the flame and of the envelope.

The fourth type of high-frequency plasma source able to operate at atmospheric pressure consists of the family of surface-wave applicators. Within the context of a surface-wave plasma source, the extent of the plasma column can be increased by simply increasing the incident microwave power, without it being necessary to redesign the field applicator. The density of the plasma in the column exceeds the critical density.

More detailed information about these various types of source are given in Chapters 4 and 5 of “Microwave Excited Plasmas”, edited by M. Moisan and J. Pelletier, Elsevier, Amsterdam, 1992.

For flow rates of the order of a few tens of liters per minute of nitrogen or air carrier gas (with PFCs and/or HFCs at a concentration of between 0.1% and 1% or a few %), it is quite possible to achieve degrees of conversion greater than 95% with an atmospheric-pressure HF plasma source.

Whatever the plasma source used (apart from torches), it employs a generally tubular chamber within which the discharge is sustained or a dielectric tube within which the discharge is generated. For example, it may be a tube of the type described in document EP 1 014 761. A tube or tubular chamber having a length of between 100 and 400 mm, for example around 300 mm, and an internal diameter of between 4 and 8 mm, avoids introducing excessively large pressure drops downstream of the pump, that is to say which would be incompatible with the roughing pump 6. This is because the roughing pump can in general operate only with, downstream, a pressure drop of at most 300 mbar, too large a pressure drop, of around 400 mbar, causing in general the roughing pump to stop, which situation, in an application in a semiconductor production line, is difficult to accept.

Despite selecting a suitable length of tube, another problem is that of the formation of solid and/or liquid deposits in the gas circuit located downstream of the roughing pump. Such deposition may occur and in turn give rise to pressure drops and/or corrosion liable to substantially impair the operation of the production unit and result in it being shut down. This is the case, for example, in regions where cooling is carried out, especially downstream of the plasma.

Moreover, in atmospheric-pressure HF discharges, and within the range of flow rates usually imposed by the pump 6 (a few tens of liters of carrier gas per minute), a radial contraction phenomenon may occur—the electron density decreases from the axis towards the periphery of the tube and the molecules of the gas flowing at the periphery encounter fewer active species over their path than those flowing close to the axis of the tube. In certain cases, the discharge may no longer fill the entire cross section and one then witnesses the appearance of several plasma filaments moving in an erratic manner, so that the conversion yield drops suddenly.

The degree of contraction depends on several factors, in particular the diameter of the tube, the nature of the dilution gas, the impurities and adjuvant gases, the velocity of the flux, the thermal conductivity of the wall of the tube and the excitation frequency. In general, all other things being equal, the degree of contraction decreases when the internal diameter of the discharge chamber is reduced or the frequency is decreased. However, the diameter of the tube cannot be reduced arbitrarily since, on the one hand, the thermal stress on the wall would increase correspondingly and, on the other hand, the pressure drop across the plasma decontamination reactor 8 might become prohibitive depending on the total flow rate (for example in the case of several roughing pumps being connected together).

Now, as already explained above, an excessive pressure drop results in the roughing pump 6, and hence the entire production unit, stopping.

The internal diameter of the tube may be selected to be between 8 mm and 4 mm in order to reduce the contraction and obtain a high degree of conversion, while not imposing an excessive pressure drop on the roughing pump 6. By operating within the most favorable conditions, the length of the discharge allowing a given degree of conversion to be obtained is reduced.

It is therefore preferable, before operating the plant, to select the internal diameter of the tube so that the contraction phenomenon is less pronounced. The use of variable diameter tubes allows the efficiency of the process to be varied.

Another way of increasing the path length of the PFC molecules in the discharge is to alter the way the gas stream flows, for example by generating a vortex so as to make the path of the particles curvilinear rather than linear.

Preferably, the tube will have a thickness of around 1 mm or between 1 and 1.5 mm.

The tube is therefore thin. In operation, the temperature of its external face is all the higher. However, it has been found (from trials lasting several hundred hours of operation) that this does not prejudice the thermal stability of the cooling fluid: this fluid does not undergo any appreciable degradation, even over a very long time.

Furthermore, a tube having a thickness of close to 1 mm allows optical measurements to be carried out in order to monitor the proper operation of the plasma source, and especially to monitor the length of the column. A plasma in air or nitrogen can be optically monitored through a tube having a thickness of 1 mm, or between 1 mm and 1.5 mm, something which is much more difficult through a tube having a thickness of 2 mm.

Depending on the type of source chosen, these general principles may be applied in various ways and may help to a greater or lesser extent in optimizing the conversion efficiency.

In a resonant cavity, the plasma density cannot greatly exceed the critical density, at least if one is confined to true cavity modes. This is because if the power is increased, surface-wave modes may appear, corresponding to standing waves if the cavity remains closed by conducting walls at its ends, travelling waves otherwise. In the case of a surface mode, the density is always greater than the critical density. For a closed cavity, the extent of the discharge along the tube is limited by the size of the cavity. The length of the latter is therefore chosen, by construction, so as to provide a sufficient plasma volume to obtain the desired conversion yield.

The same type of consideration applies to a discharge in a waveguide. In this case, one dimension of the cross section of the waveguide determines the maximum length of discharge, unless, for a sufficient power and depending on the configuration of the waveguide, the wave propagates outside the latter, which then becomes a surface-wave applicator. The dimensions of the waveguide will furthermore satisfy the conditions for the existence of the guided propagation mode at the frequency in question.

The case of a torch is substantially different, both the inner cone and the envelope of the plasma flame emerging in a chamber whose dimensions are generally quite large compared with those of the nozzle, so as not to disturb the regularity of the flow and the symmetry of the flame. This chamber is used to collect the stream of gas laden with by-products, so as to direct it towards the post-treatment means located downstream. The details of the shape of the nozzle (the number and dimensions of the orifices and the position in the cross section) play a role in controlling the path of the species in the flame. It may also be pointed out that the flow in the chamber may be optimized for the same purpose.

Finally, in the case of a surface-wave plasma, the extent of the discharge is not limited by the size of the conducting structure of the field applicator, which consequently does not need to be matched according to the desired performance. The length of the discharge in the tube may be increased to the desired value by increasing the incident HF power delivered by the generator.

The gas circuit of all of the treatment means of the system in FIG. 1 comprises, starting from the roughing pump 6, the line 7 conveying the effluents into the reactive plasma module 8, then the line 9 linking the plasma to the by-product post-treatment device 10 and finally the line 12 for venting into the atmosphere the detoxified gases which can be discharged without any danger. To these may be added various fluid management components (by-pass valves and purging and isolating utilities for maintenance) and safety sensors (flow-fault and overpressure alarms), these not being shown in FIG. 1. The circuit components are chosen to be compatible with the products with which they are in contact for reliable operation.

Oven-drying or trapping systems may furthermore be present.

This is because the effluents extracted by the roughing pump 6, and returned to atmosphere pressure, do not all necessarily remain in gaseous form. The problems are generally aggravated by the presence of any residual moisture (a few hundreds of ppmv) in the dilution gas. For example, an SF₆ etching process may produce solid sulfur, H₂SO₄ and HNO₃, etc. Certain effluents may condense or be deposited in solid form, thus running a risk of increasing the pressure drop downstream of the pump 6. As a result, there is a risk, already mentioned above, of the roughing pump 6, and with it the entire production unit, stopping.

Moreover, the diameter of the tubular plasma chamber, given the radial contraction phenomenon already mentioned above, may not in general exceed about ten mm. For a total flow rate of the order of a few tens of slm (imposed by the roughing pump 6), the velocity of the gas stream is such that the heat exchange (radial heat diffusion) is too slow for most of the thermal energy generated in the plasma to be carried away by the fluid for cooling the chamber. As a result of the microwave power needed to sustain a sufficiently dense plasma in nitrogen or air being very high, a considerable enthalpy is transported downstream of the discharge chamber. In this region, the gas is rapidly cooled by cooling means, for example by means of a water heat exchanger structure, in order to prevent the line from being destroyed. By doing this, a preferred region for the condensation of residues, corrosion and/or blockage of the said line is thus created, and hence, again, there is a risk of increasing the pressure drop downstream of the pump 6.

Under these conditions, according to one embodiment of the invention, unlike in all the current existing plasma plants, the decontamination reactor 8 is prevented from being operated with an ascending stream, with the exchanger at the top of the reactor.

Furthermore, in the case of an ascending stream, solid and liquid residues may return to the plasma chamber simply under gravity, and impair its operation. It has been observed, for example in the case of SF₆ etching, that sulfuric acid, a viscous liquid with a low vapour pressure, wetting the internal wall of the tube, precludes any re-ignition of the plasma because of its poor dielectric properties. The tube must then be rinsed and dried, all the more awkward because of its geometry.

It is therefore preferable, for these reasons, to reverse the direction of flow of the gas stream and to make it flow downwards. Optionally, draining means may be provided in the bottom position of the tube, for example an exchanger-collector structure allowing the liquid residues to drain to the bottom point.

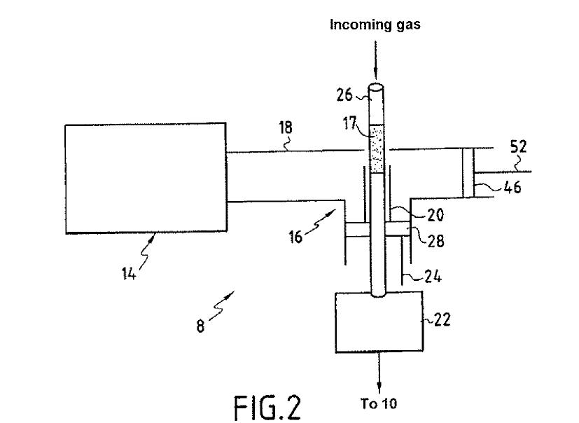

FIG. 2 shows treatment means 8 according to the invention, comprising a microwave generator 14, a waveguide 18 and a discharge tube 26. The latter is placed in a sleeve 20, made of a conductive material and as described, for example in document EP-820 801.

This surfatron-guide is furthermore provided with means 24, 52 for adjusting the axial position of the waveguide plunger 46 and of the tuning plunger 48 coaxial with the discharge tube. This second plunger forms a quarter-wave trap. It is fixed to a sliding disc 50, for example made of Teflon. The means 24, 52 are in fact rods that can be manually actuated for the purpose of adjusting the impedance of the system.

In FIG. 2, the gas is shown flowing downwards, in accordance with what was explained above. The reference number 22 furthermore denotes draining means in the bottom position of the tube 16, for draining the liquid residues to the bottom point.

The length of the lines may influence the nature of the products which actually reach the post-treatment system 10. It may be indicated, in the case of a system 10 with a solid reactive adsorbent, to locate the said system as close as possible to the plasma outlet, so that it treats only gaseous products for which it is specifically designed.

The specifications of the post-treatment system 10 are preferably chosen in order to take account of the generation of by-products (corrosive fluorinated gases such as HF, F₂, COF₂, SOF₂, etc., nitrogen oxides, etc.) by the process and the PFC conversion plasma. Making use of the departure from thermodynamic equilibrium does not provide absolute flexibility for controlling the respective concentrations of these by-products.

Furthermore, certain features of the post-treatment device 10 may be imposed a priori, for example in the case of already existing plants or established decontamination methods at the user's premises.

In general, cooling means (not shown in FIG. 1) are provided for the plasma source (especially for the discharge chamber and the gas outlet) and the electromagnetic energy supplies. Apart from the thermal power to be extracted, certain temperature ranges may be imposed, for example in order to prevent condensation upon stopping. The architecture of the cooling circuits is therefore preferably tailored so as to be able to use, as refrigeration sources, the standard cold-water networks in the plant.

The incident HF power is an operational parameter both of the electromagnetic energy circuit and the plasma source. In order for the source to operate under proper energy efficiency conditions (effective transmission of the power into the plasma), it is sought to minimize the power reflected by the generator and the heating losses in the field applicator structure.

Depending on the design of the plasma source, external adjustment means, such as short-circuiting plungers 46 (FIG. 2) which can move at the end of the waveguide or tuning screws, can be used so as to ensure correct impedance tuning.

Impedance tuning may be relatively insensitive to the operating conditions (equipment start/stop, multi-step process, drift, and fluctuations). The systems based on cavities are, for example, “sharper” than surface-wave systems and it may be indicated to provide automatic tuning means slaved to the reflected power measurement. The reflected power is also, in general, a parameter characterizing the proper operation of the plasma source, malfunctions generally being associated with an appreciable increase in the reflected power.

However, this is not systematic and other physical parameters may be used to ensure proper operating safety, such as certain signatures characteristic of plasma (extent, luminosity, etc.), which may be diagnosed by optical sensors, or abnormal thermal variations in the plasma source. The latter is furthermore provided with suitable initiation means. This is because a nitrogen or air plasma cannot be spontaneously initiated at atmospheric pressure when the HF power is established.

In practice, there may be constraints associated with integration and operation in a semiconductor fabrication unit. However, as a general rule, the proposed structure according to the invention may be consistent with the methods of operating the process machines in this field and with the general practices of semiconductor manufacturers, for example in the case of intermittent operation only during the process phases, with suitable stop/start procedures and a unit for interfacing the controllers with the pump and with the deposition/etching equipment.

It is also compatible with taking up a small amount of floor space, often imposed by the structures of semiconductor production units because of the scarcity and the cost of floor space in semiconductor fabrication plant facilities floors.

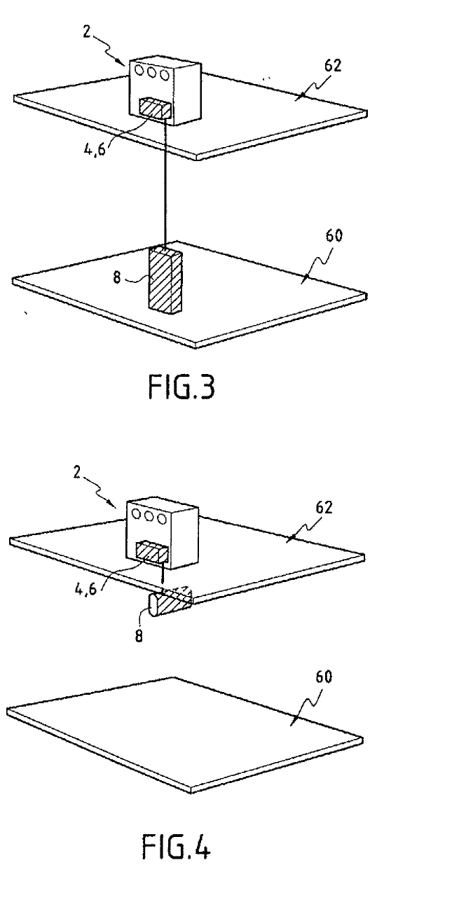

As illustrated in FIGS. 3 and 4, various arrangements may be chosen.

The treatment unit 8 may be located a few meters (for example, less than 5 m) from the machine or reactor 2 or from the roughing pump 6, on the facilities floor 60 in the production unit, as in FIG. 3. The reactor 2 itself is located in the fabrication shop 62.

In the case of FIG. 4, the treatment unit may be more compact and integrated, with the vacuum pump 6, and as close as possible to the equipment 2, on the floor of the fabrication shop 62.

One particular illustrative example will now be given. It relates to a surface-wave system for an SF₆/C₄F₈ etching reactor.

### Microwave Circuit and Field Applicator

The chosen excitation frequency was 2.45 GHz. Transfer of microwave power sufficient for the application (several kW) is possible, at this frequency, using a waveguide, generally to the WR 340 standard, having a cross section of reasonable size. The field applicators may be of the surfatron-guide or surfaguide type, the latter providing greater simplicity. A surfaguide allows excellent impedance tuning merely by adjusting the position of the movable short-circuiting plunger closing off the waveguide at its end, without having to use a three-screw matcher.

The microwave circuit therefore comprises:
a microwave generator (switched-mode power supply and magnetron head) with adjustable power up to a maximum power of 6 kW;
a circulator with a water charge suitable for dissipating all of the reflected power, so that none of it is returned to the magnetron;
means for measuring the incident power and the reflected power;
the surfaguide field applicator, together with the dielectric discharge tube, constituting the plasma source;
finally, a movable short-circuiting plunger, operated by hand or motor-driven, at the end of the waveguide, for impedance tuning.

### Gas Circuit

This is basically made of a material resistant to the fluorinated corrosive products, i.e. a polymer of the PVDF or PFA type, except for the active parts of the plasma source 8 and the components where there is considerable heat generation, such as the immediately downstream line element contiguous with the discharge tube, which remain made of metallic or ceramic materials.

On the exhaust side of the rough-vacuum pump 6, a system of by-pass valves (a three-way valve or three two-way valves, depending on the commercial availability of suitable components) makes it possible to avoid the treatment system via the gas stream in the event of an operating incident or during maintenance phases. These valves are mechanically or electrically interfaced so as to prevent any inopportune closure of the exhaust, which would cause the pressure to rise and the pump to stop. The plasma decontamination unit 8 itself includes means for detecting any excess pressure drops in the stream of gas to be treated.

The discharge tube is a double-walled tube, the cooling being provided by the circulation between these two walls of a dielectric fluid by means of a hydraulic gear pump. This fluid is in turn cooled continuously by heat exchange with the cold mains water delivered to the facilities of the semiconductor fabrication unit. The central tube, in contact with the plasma, is made of a suitable ceramic material, which is a good dielectric, refractory and resistant to thermal stresses and also to chemical attack by the corrosive fluorinated species.

On leaving the discharge tube, the gas may be at a high temperature since the atmospheric-pressure microwave plasma, although in general not being in thermal equilibrium, is not a “cold” plasma similar to low-pressure discharges. The gas is therefore cooled, by a water heat exchanger, before being sent into the downstream line. This cooling may cause, locally, the condensation of liquid or solid products which it is desirable to be able to collect suitably, in order not to risk the plant being blocked. For this reason, as already explained above, the operation is carried out with a descending stream, with the exchanger located in a low position. A suitable tap-off makes it possible, when necessary, to drain the collector at regular intervals.

The device 10 for neutralizing the corrosive fluorinated gases is preferably installed a short distance downstream of the plasma. It is a cartridge with a solid reactive adsorbent, preferably designed to fix molecular fluorine, which will be the main by-product if the etching or cleaning process does not use water or hydrogen. The bed also retains, in a lesser amount, the etching products such as SiF₄ or WF₆, and other dissociation products from the process plasma or the decontamination plasma, such as COF₂, SOF₂, etc.

The gas circuit includes a number of manually operated or motor-driven valves, making it possible to isolate, purge, and flush the various parts of the system with an inert gas.

### Cooling Fluids Circuit

The water delivered to the facilities of the semiconductor fabrication plant is used to cool the switched-mode power supply and the magnetron head of the generator, the dielectric fluid for cooling the discharge tube and the gas on the output side of the plasma tube. To extract the heat from the dielectric fluid, water from the actual cold mains is used, in a closed circuit (about 5° C.) in a plate exchanger. On the other hand, in the case of the generator, it is not desirable to risk condensation phenomena that could cause short-circuits. It will therefore be preferable to use the “town” water at about 20° C., which will circulate in succession in the switched-mode power supply and the magnetron head, and then in the exchanger-collector remote from the plasma. In practice, this “town” water will also come from a closed circuit and its temperature is preferably regulated centrally if a large number of machines have been installed.

### Example of the Process and Performance

A plasma decontamination system, according to the invention, was installed as shown in the diagram in FIG. 1 downstream of an ALCATEL 601E plasma etching machine 2. The chemistry for etching single-crystal silicon used, in sequence, the gases SF₆ and C₄F₈ (14″-3″, for example) with respective flow rates of 170 sccm and 75 sccm.

In practice, after passing through the vacuum pumps 4, 6 and the output line, the gases entered the plasma decontamination unit 8 with a concentration averaged over time. With the concentrations indicated above, the SF₆ entered the unit 8 with a concentration of 90 sccm, accompanied by C₄F₈ with a concentration of 24 sccm.

The system 10 for neutralizing the fluorinated acid gases was a commercially available cartridge of the CleanSorb™ brand. The stream of gaseous effluents was analyzed at various points in the system by quadrupole mass spectrometry.

The ALCATEL etching process used the PFC gases SF₆ and C₄F₈. The exhaust from the roughing pump 6 was diluted with dry air (approximately 100-150 ppm residual H₂O) at 30 slm. The SF₆ and C₄F₆ concentrations were measured downstream of the etching chamber 2 (high-density ICP source). The degrees of destruction in the decontamination plasma were calculated as the ratio of the concentration on leaving the said plasma to the concentration on entering the said plasma, i.e. without including the prior dissociation by the etching process itself.

The output from the decontamination plasma 8 contained, apart from the residual concentrations of the two PFCs, the following by-products: SiF₄, F₂, COF₂, SOF₂, NO₂, SO₂, NOF and, possibly, HF because of the residual moisture in the dilution air. After passing over the neutralization cartridge 10, none of these pollutants dangerous to the air was present in the gas stream with a concentration greater than the average or limiting exposure value.

The degree of abatement of C₄F₈ was almost 100%, the residual concentration being less than the detection noise level. The degrees of abatement of SF₆ are given in Table I for various conditions. It may be clearly seen that the degree of abatement increases with the incident microwave power, that is to say with the extent of the plasma region. It may also be seen that the destruction efficiency, all other things being equal, increases when the diameter of the tube decreases. Furthermore, the direction in which the gas stream flows—ascending or descending—has little effect on the destruction efficiency, but makes it possible to avoid certain risks already mentioned above.

Similar results were obtained with higher flow rates of SF₆ (up to 300 scmm) and with greater dilutions (up to 70 slm), and for other PFCs, such as C₃F₈, NF₃, C₂F₆, CF₄, CHF₃, etc.

In Table I, the “process inlet” denotes the inlet of the reactor 2 and the “detox inlet” denotes the inlet of the treatment device 8.

TABLE I

| | SF₆ flow | SF₆ flow | | | | | | | |
|---|---|---|---|---|---|---|---|---|---|
| Tube Ø | rate, process | rate, detox | Dilution gas | | Additive | Degree of destruction | | | |
| (mm) | inlet (slm) | inlet (slm) | Air (slm) | N₂ (slm) | O₂ (slm) | Pₘᵢₙ (kW) | % | Pₘₐₓ (kW) | % |
| 10⁽¹⁾ | — | 170 | — | 20 | 1 | 3 | 70 | 3 | 70 |
| | 170 | 75 | 30 | — | — | 3 | 70 | 3 | 70 |
| 8⁽¹⁾ | — | 170 | — | 20 | 1 | 3 | 97 | 3.5 | 98 |
| | 170 | 75 | 30 | — | | 2.5 | 94 | 3.5 | 97 |
| 6⁽¹⁾ | — | 170 | — | 20 | 1 | 1.6 | 95 | 2.5 | 99 |
| 10⁽²⁾ | — | 300 | 30 | — | 0.45 | 3.5 | 77 | 3.5 | 77 |
| 8⁽³⁾ | — | 200 | 20 | — | 0.3 | 3.5 | 97 | 3.5 | 97 |
| 10⁽³⁾ | — | 200 | 20 | — | 0.3 | 3.5 | 81 | 3.5 | 81 |
| 12⁽²⁾ | — | 200 | 20 | — | 0.3 | 3.5 | 67 | 3.5 | 67 |

⁽¹⁾Measurement on alpha-test with off/on etching process
⁽²⁾Laboratory measurement with ascending stream
⁽³⁾Laboratory measurement with descending stream

The invention has been described within the context of a chamber 2 for the production or etching of semiconductor components.

It applies in the same way, and with the same advantages, to the case of a chamber or reactor 2 for the production or growth or etching or cleaning or treatment of semiconductors or semiconductor or thin-film devices or semiconductor or conducting or dielectric thin films or substrates, for example silicon substrates during the fabrication of microcomponents or microoptic devices.

It also applies, again with the same advantages as described above, in the case of a reactor for removing photosensitive resins used for microcircuit lithography, or else in the case of a reactor for depositing thin films during plasma cleaning.

This invention relates to the field of treatment of gases by plasma technologies, and especially the treatment of gases such as perfluorinated gases particularly perfluorocarbon gases, and for hydrocarbon gases for the purpose of destroying them.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

What is claimed is:

1. A process for treating semiconductor fabrication effluents with plasma, the process comprising the steps of:
Obtaining the semiconductor fabrication effluent from an outlet of a pump at a pressure substantially equal to atmospheric pressure;
Diluting the semiconductor fabrication effluent;
Sustaining plasma not in local thermodynamic equilibrium in a plasma discharge tube at a frequency greater than 50 MHz; and
Passing the diluted semiconductor fabrication effluent in a downward direction through the plasma in the plasma discharge tube.

2. The process of claim 1, wherein the semiconductor fabrication effluent is diluted with dry nitrogen.

3. The process of claim 2, wherein the dry nitrogen is obtained by cryogenic distillation.

4. The process of claim 1, wherein the semiconductor fabrication effluent is diluted with air.

5. The process of claim 1, wherein the plasma is sustained at a frequency selected from the group consisting of the bands centered on 433.92 MHz, 915.00 MHz, 2.45 GHz, and 5.80 GHz.

6. The process of claim 1, wherein the semiconductor fabrication effluent comprises one or more of a perfluorinated gas or a hydrofluorocarbon gas.

7. The process of claim 1, wherein the semiconductor fabrication effluent contains one or more of SF₆ or C₄F₈.
